(19) United States
(12) Patent Application Publication
(10) Pub. No.: US 2014/0095732 A1
(43) Pub. Date: Apr. 3, 2014

(54) METHOD OF RESOLVING SUBSCRIBER IDENTIFIERS

(71) Applicants: Nahla Abid, Rennes (FR); Philippe Bertin, Acigne (FR)

(72) Inventors: Nahla Abid, Rennes (FR); Philippe Bertin, Acigne (FR)

(73) Assignee: ORANGE, Paris (FR)

(21) Appl. No.: 14/008,928

(22) PCT Filed: Mar. 26, 2012
(86) PCT No.: PCT/FR2012/050628

§ 371 Date: Dec. 10, 2013

(30) Foreign Application Priority Data
Mar. 31, 2011 (FR) 1152714

(51) Int. Cl. H04L 29/12

(52) U.S. Cl. CPC H04L 61/10
USPC 709/245

(57) ABSTRACT

A method is provided to resolve subscriber identifiers for implementation of an electronic communication service supported by an electronic communications network, between a first subscriber to a first service provider and a second subscriber to a second service provider. The method includes the following steps: receiving a request for resolution of subscriber identifiers including a primary identifier of the second subscriber and at least one identifier of the service requested by the first subscriber; obtaining at least one secondary identifier of the second subscriber, corresponding to the service requested by the first subscriber, by consulting a subscriber identifier resolution table, this table associating a secondary identifier of a subscriber with a pair {primary identifier of the subscriber; identifier of a service subscribed to by the subscriber}; dispatching a subscriber identifier resolution response including the secondary identifier of the second subscriber, corresponding to the service requested by the first subscriber.

### 1. CROSS-REFERENCE TO RELATED APPLICATIONS

This application is a Section 371 National Stage Application of International Application No. PCT/FR2012/050628, filed Mar. 26, 2012, which is incorporated by reference in its entirety and published as WO 2013/011214 on Jan. 24, 2013, not in English.

### 2. FIELD OF THE INVENTION

The field of the invention is that of electronic communications across interconnected networks, and more precisely that of the naming of the communicating entities.

### 3. PRIOR ART

The establishment of a communication between two communicating entities in the Internet network is done with the aid of their respective IP (Internet Protocol) addresses, which allow the routing of the data between the two entities. As these IP addresses are numerical, long and difficult for human beings to manipulate, or indeed impossible to manipulate in the case of IPv6 addresses (comprising 128 bits rather than 32 in IPv4), the communicating entities are commonly designated by descriptors consisting of alphanumeric character strings, which are easier to memorise. These alphanumeric descriptors are called FQDN (Fully Qualified Domain Name) addresses. The FQDNs include the name of the domain DNS (Domain Name Space) to which the communicating entity belongs, and optionally other information such as a user or machine name. The resolution of these descriptors into IP addresses is done through a system called DNS, and this is why they are also called “DNS domain names”. The DNS is implemented by computer servers distributed throughout the world.

Today's Internet is therefore based on two naming spaces: IP addresses, which serve to locate resources, and FQDN addresses, which serve to name them. Resolution between these two spaces is ensured by the DNS servers. However, the use of these naming spaces is becoming increasingly problematic for the following reasons. Firstly, the DNS servers are not sufficiently suited to the escalation in the number of mobile terminals that are able to access the Internet. This is due to the unwieldiness of the updating processes in the case of roaming, which generally suffer from fairly significant lags. Moreover, the FQDN addresses which have long been reserved for naming terminals, are no longer sufficiently suited to the increased sophistication of the services and uses of communications between users. Moreover, the changing of IP address while a terminal is roaming requires the re-establishment of connections at the level of the transport layers, thereby affecting the quality of the communications and the performance of the network.

A way of partially remedying the problems described hereinabove is to introduce extra levels of address resolution. In the document “A Layered Naming Architecture for the Internet” (LNA being the abbreviation standing for Layered Naming Architecture) published by H. Balaksrishnan et al during the SIGCOMM conference in 2004, a descriptor is resolved in a first level into a service identifier, which is in its turn resolved in a second level into a terminal identifier on which the service is executed, which is itself finally resolved in a third level into an IP address of the corresponding terminal. This makes it possible to decouple the services from the terminals on which they execute, by identifying them separately, thereby improving the flexibility of management of roaming and of migration of services between terminals. This also affords an improvement as regards the roaming of the terminals, which once identified separately from the IP addresses, retain intact their connections at the level of the transport layer, during a roaming procedure.

Despite these improvements the LNA solution still presents a certain number of drawbacks.

A first drawback of LNA is not to be able to determine in advance whether a user has subscribed to a service without attempting to establish a session, that is to say not to be able to determine the non-availability of a terminal and therefore of a service that it is presumed to support.

A second drawback of LNA is to base the last two resolution levels respectively on the terminal and the IP address of the terminal. On each arrival of a new terminal in the network, a request with a view to the recording of the corresponding identifier is required. With the number of terminals connected to the Internet undergoing very steep growth, this entails problems of scalability and of storage at the level of the number, size and frequency of updating of the resolution structures.

A third drawback of LNA is not to allow the end routers to operate a maximum of choices specific to users. LNA is not suitable for solving new problems related to the fact that users increasingly often have several terminals at their disposal for consuming one and the same service. LNA does not have the capacity to select, from among several available terminals, the one most suitable for offering the type of service requested at a given instant. Likewise the roaming of one and the same session on the various terminals of one and the same user requires in LNA the issuing of new resolution requests, which are in general global and therefore expensive, in order to find the identifier of the new terminal to which the session will migrate.

Starting from this finding, the inventors have thought about a solution which improves the situation.

### 4. DISCLOSURE OF THE INVENTION

The invention relates to a method for resolving subscriber identifiers for the implementation of an electronic communication service, supported by an electronic communications network, between a first subscriber to a first service provider and a second subscriber to a second service provider, characterized in that it comprises the following steps:
Reception of a subscriber identifiers resolution request comprising a primary identifier of the second subscriber and at least one identifier of the service requested by the first subscriber,
Obtaining of at least one secondary identifier of the second subscriber, corresponding to the service requested by the first subscriber, by consultation of a table for resolving subscriber identifiers, this table associating a secondary identifier of a subscriber with a pair {primary identifier of said subscriber; identifier of a service signed up to by said subscriber},
Sending of a subscriber identifiers resolution response comprising the secondary identifier of the second subscriber, corresponding to the service requested by the first subscriber.

This method makes it possible to determine in advance whether the second subscriber has signed up to the service for which the first subscriber desires to establish a communication session, without waiting for the ultimate phase of the implementation of the communication session.

The subscriber identifiers resolution table consulted by the method is a resolution table implemented by the service provider of the second subscriber. This service provider must update it each time that a subscriber signs up to a service offered by this provider, or cancels it. The service provider allocates the subscriber a subscriber primary identifier, nonspecific to the service requested, and a subscriber secondary identifier, per service to which the subscriber has signed up. The subscriber primary identifier is the identifier that the provider must declare publicly in a global resolution structure.

According to one aspect of the invention, the method for resolving subscriber identifiers is characterized in that the secondary identifier of a subscriber comprises at least the following fields:
primary identifier of the subscriber,
service identifier,
   and in that the primary identifier of the subscriber comprises at least the following fields:
identifier of the subscriber,
identifier of the service provider of the subscriber.

The primary identifier of a subscriber makes it possible to identify the service provider of this subscriber but not the service to which he has signed up, whereas the secondary identifier of a subscriber makes it possible to identify at one and the same time to which service the subscriber has signed up and with which service provider.

According to another aspect of the invention, the method for resolving subscriber identifiers is characterized in that the subscriber identifiers resolution request comprises a secondary identifier of the first subscriber corresponding to the requested service, and in that the method comprises a step of extracting the service identifier on the basis of the secondary identifier of the first subscriber.

Thus, in the subscriber identifier resolution request, so as to obtain the secondary identifier of the second subscriber for the service requested by the first subscriber, the service identifier can be extracted from the secondary identifier of the first subscriber.

On account of the structure of the secondary identifiers, the table for resolving subscribers can reduce to a list of secondary identifiers.

If the table for resolving subscriber identifiers does not contain any entry corresponding to the pair {primary identifier of the second subscriber; identifier of the service signed up to by the first subscriber}, then the second subscriber has not signed up with his own service provider to the service signed up to by the first subscriber, or to a compatible service. In this case, advantageously, the method responds that the implementation of a communication session with the first subscriber is not possible. The following phases of the implementation of the communication session are not performed, thereby avoiding needlessly calling upon the resolution and routing infrastructures downstream.

According to another aspect of the invention, the method for resolving subscriber identifiers is characterized in that, if the table for resolving subscribers does not contain any entry corresponding to the pair {primary identifier of the second subscriber; identifier of the service requested by the first subscriber}, the subscriber identifiers resolution response comprises at least one secondary identifier of the second subscriber whose service identifier field is compatible with the service requested by the first subscriber.

In this advantageous variant, if the table for resolving subscriber identifiers contains one or more entries corresponding to the second subscriber, but without the same service identifier as that requested by the first subscriber, the method can verify among the entries whether one or more have a service identifier compatible with the request. The existence of one or more entries satisfying this condition signifies that the second subscriber has signed up to as many distinct services with his service provider, which are compatible with the service signed up to by the first subscriber. Advantageously, the method can therefore send a response per entry, thus giving a choice or a solution for replacement to the first subscriber, that may be useful to him subsequently if for example for any reason the communication cannot be established with a first service identifier during a first attempt.

The invention also relates to a routing method for the implementation of an electronic communication service supported by an electronic communications network, between a first subscriber to a first service provider and a second subscriber to a second service provider, comprising the following steps:
Reception of a data message intended for the second subscriber, comprising payload data, a secondary identifier of the first subscriber, and a secondary identifier of the second subscriber,
Extraction of the secondary identifier of the second subscriber,
Determination of a service provider of the second subscriber and of a service requested by the first subscriber, with the aid of the extracted secondary identifier,
Emission of an access router addresses resolution request comprising the secondary identifier of the second subscriber, to a server for resolving access router addresses which is specific to the service provider and to the service determined,
Obtaining of at least one address of an access router to which is attached the second subscriber for the service requested by the first subscriber,
Transmission of a data message to the access router address obtained, the message comprising at least the payload data, the secondary identifier of the first subscriber, the secondary identifier of the second subscriber, the access router address obtained.

Once it is determined that the second subscriber has indeed signed up to a service for which the first subscriber desires to establish a communication session, this method allows a first access router, to which the first subscriber is attached, to route the payload data toward a second access router, to which the second subscriber is attached. The secondary identifier of the second subscriber, included in the payload data message, indeed allows the first access router to determine where to find the address of the second access router. The second access router, receiving this message, transmits it to the second subscriber. Thus, it is not necessary for the first access router to know the exact location of the second subscriber.

In order to obtain an access router address as a function of the secondary identifier of the second subscriber, a server for resolving access router addresses is consulted. This server implements the following steps:
Reception of an access router addresses resolution request comprising a secondary identifier of the second subscriber for the service requested by the first subscriber,
Obtaining of at least one address of an access router to which is attached the second subscriber for the service requested by the first subscriber, by consultation of a table for resolving access router addresses, this table associating an access router address with a subscriber secondary identifier,
Sending of an access router addresses resolution response comprising said at least one address of the access router to which is attached the second subscriber for the service requested by the first subscriber.

This server for resolving access router addresses allows the transfer of the data of the communication session between a first access router, to which the first subscriber is attached and a second access router, to which the second subscriber is attached.

If the table for resolving addresses of routers does not contain any entry corresponding to the secondary identifier of the second subscriber, the reason may be that, for example, the second subscriber, although having subscribed to the requested service, may not yet have had time to attach himself to an access router. In this case, advantageously, the method responds that the implementation of a communication session with the first subscriber is not possible with this secondary identifier of the second subscriber. This allows the first access router either to attempt the same request after a time span has elapsed, or to attempt a new resolution request comprising a secondary identifier of the second subscriber which is different, on condition that this alternative secondary identifier is at the disposal thereof.

The invention also relates to a method for updating a table for resolving attachment IP addresses, characterized in that it comprises the following steps:
Reception of a modification message relating to the attachment of a subscriber to an electronic communications network, comprising a secondary identifier of the subscriber and an attachment IP address,
Addition/removal, in a table for resolving attachment IP addresses, of an entry corresponding to the pair {secondary identifier of the subscriber; attachment IP address}.
Triggering of the sending of an update message in respect of a table for resolving access router addresses, as a function of the type of modification relating to the attachment, and of the state of the table for resolving attachment IP addresses.

The table for resolving attachment IP addresses is used by the access router associated with the second subscriber to determine the final destination of the communication session data emitted by the first subscriber. This table for resolving attachment IP addresses is updated by the access router associated with the second subscriber, each time that the latter attaches himself to the electronic communications network, via the access router, with a subscriber secondary identifier and an associated attachment IP address, as well as on each detachment.

In the context of the invention, the attachment of a subscriber, of a terminal or of a service signify equally: a declaration of start of use of a service by a subscriber on a terminal, performed through an access router. The secondary identifier of the subscriber makes it possible to identify the subscriber, the service and the service provider, while the attachment IP address makes it possible to identify the instantiation of the service on the terminal of the subscriber. It is important to note that one and the same terminal can support several services, each with its distinct attachment IP address. Similarly, the detachment of a subscriber, of a terminal or of a service signify equally: a declaration of end of use of a service by a subscriber on a terminal, performed through an access router.

A new entry is added to the table for resolving attachment IP addresses during an attachment with a new pair {secondary identifier of subscriber; attachment IP address}, previously absent from the table for resolving attachment IP addresses.

Similarly, an entry {secondary identifier of subscriber; attachment IP address} is removed from the table for resolving attachment IP addresses during the detachment of the subscriber with this pair.

These additions and removals arise frequently, for example in a roaming situation with one and the same terminal detaching from one access router so as to attach to another, or when the second subscriber declares a new service on a terminal supporting another service already attached to the access router, or transfers to a new terminal an existing service, off-session or in-session, without changing or while changing access router.

Limiting these updates of combinations {secondary identifier of subscriber; attachment IP address} to the access routers, makes it possible not to encumber the other resolution methods situated upstream with the numerous updates due to the roaming of the subscribers and to the multiplicity of their terminals.

Subsequent to the updating of the table for resolving attachment IP addresses, the access router triggers the sending of an update message in respect of a table for resolving access router addresses, if and only if one of the following two conditions is satisfied:
in the case of an attachment, no other entry with the same subscriber secondary identifier existed prior to the addition of the entry to the table for resolving attachment IP addresses,
in the case of a detachment, no other entry with the same subscriber secondary identifier exists after the removal of the entry from the table for resolving attachment IP addresses.

By thus limiting the sendings of update messages in respect of a table for resolving attachment IP addresses, the choice between the various attachment IP addresses associated with the same secondary identifier of the second subscriber is performed locally by the access router of the second subscriber, as close as possible to the second subscriber, and not by another resolution structure further upstream.

The update message in respect of a table for resolving access router addresses comprises a secondary identifier of the second subscriber, the address of the access router with which the table for resolving attachment IP addresses is associated, that is to say the address of the access router to which the second subscriber is attached, as well as an addition/removal instruction. This message is sent to an entity of the network, such as for example a server of the service provider of the second subscriber performing the translation between secondary identifiers of subscribers and addresses of access routers.

In order to determine to which entity to send these update messages, the access router, which is not necessarily managed by the service provider of the second subscriber, examines the “identifier of the service provider of the subscriber” field and the “service identifier” field, which are contained in the secondary identifier of the second subscriber.

Advantageously, if the updating takes place in the course of a communication session, and affects the secondary identifier of the second subscriber and/or the address of the access router to which the second subscriber is attached, said identifier and said address can also be sent to the access router of the first subscriber, so as to ensure the continuity of the routing of the data of the session.

The invention also relates to a method for updating a table of addresses of access routers, characterized in that it comprises the following steps:
Reception of an update message in respect of a table for resolving access router addresses, comprising a subscriber secondary identifier, an access router address as well as an addition/removal instruction,
Addition/removal, in the table for resolving access router addresses, of an entry corresponding to the secondary identifier of the subscriber and the access router address.

The updating of the table for resolving access router addresses, by the service provider of the second subscriber, is performed on receipt of update messages sent by the access router associated with the second subscriber.

It is important to note that in the context of the invention, an access router is not necessarily managed by the service provider of the first subscriber, nor by that of the second subscriber.

This updating method allows the service provider of the second subscriber to ascertain at any moment the address of the access router closest to each of his subscribers, whatever the service requested by the first subscriber.

The invention further relates to a device for resolving subscriber identifiers which is able to implement the method for resolving subscriber identifiers which has just been described.

The invention further relates to a routing device able to implement the routing method which has just been described.

The invention also relates to a device for updating a table for resolving attachment IP addresses which is able to implement the method for updating a table for resolving attachment IP addresses which has just been described.

The invention also relates to a device for updating a table for resolving access router addresses which is able to implement the method for updating a table for resolving access router addresses which has just been described.

The invention further relates to a server for resolving subscriber identifiers which is able to manage the resolution of subscriber identifiers, comprising a device for resolving subscriber identifiers.

The invention also relates to a server for resolving access router addresses which is able to manage the resolution of access router addresses and the updating of a table for resolving access router addresses, comprising a device for updating a table for resolving access router addresses.

The invention also relates to an access router able to manage the routing of the data and the updating of a table for resolving attachment IP addresses, comprising a routing device and a device for updating a table for resolving attachment IP addresses.

The invention also relates to a system for resolving identifiers and addresses for the implementation of an electronic communication service between a first subscriber to a first service provider and a second subscriber to a second service provider, comprising at least one device for resolving subscriber identifiers, at least one routing device, at least one device for updating a table for resolving attachment IP addresses, and at least one device for updating a table for resolving access router addresses.

The invention is also aimed at a computer program comprising instructions for the implementation of a method for resolving subscriber identifiers, and/or of a method for updating a table for resolving attachment IP addresses, and/or of a method for updating a table for resolving access router addresses, when this program is executed by a processor.

This program can use any programming language, and be in the form of source code, object code, or of code intermediate between source code and object code, such as in a partially compiled form, or in any other desirable form.

### 5. PRESENTATION OF THE FIGURES

Other advantages and characteristics of the invention will be more clearly apparent on reading the following description of a particular embodiment of the invention, given by way of simple illustrative and nonlimiting example, and of the appended drawings, among which:

FIG. 1 represents the functional architecture of a system for resolving identifiers and addresses, for the implementation of an electronic communication service between a first subscriber to a first service provider and a second subscriber to a second service provider, according to a particular embodiment of the invention;

FIG. 2 represents in a schematic manner an exemplary structure of the primary and secondary subscriber identifiers according to a particular embodiment of the invention;

FIG. 3 represents a particular example of implementation, according to a particular embodiment of the invention, of an electronic communication service between a first subscriber to a first service provider and a second subscriber to a second service provider, relying inter alia on the use of the method of subscribers identifier resolution, and on the use of the method for resolving access router addresses;

FIG. 4 represents a particular example of implementation, according to a particular embodiment of the invention, of an electronic communication service between a first subscriber to a first service provider and a second subscriber to a second service provider, relying inter alia on the use of the method for updating a table for resolving attachment IP addresses, and on the use of the method for updating a table for resolving access router addresses.

### 6. DETAILED DESCRIPTION OF AT LEAST ONE EMBODIMENT OF THE INVENTION

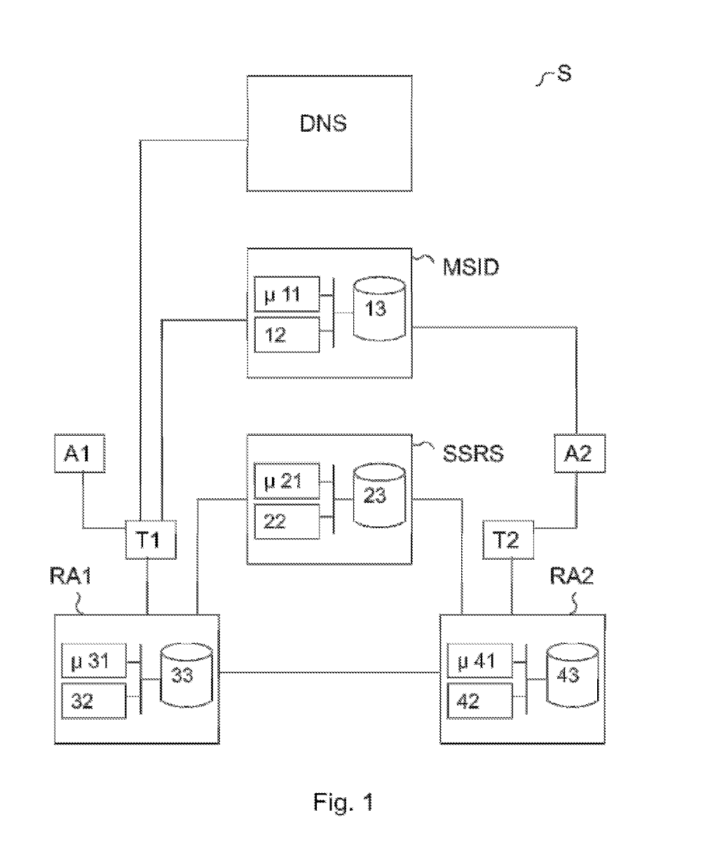

FIG. 1 illustrates the general principle of the invention by an exemplary architecture of a system for resolving identifiers and addresses, referenced S in FIG. 1, for the implementation of an electronic communication service between a first subscriber to a first service provider and a second subscriber to a second service provider.

A terminal T1 of the first subscriber A1 is attached to the access router RA1. A terminal T2 of the second subscriber A2 is attached to the access router RA2. In order to establish on the initiative of the subscriber A1 an electronic communication service between T1 and T2, RA1 must ascertain the address of RA2, and then RA2 must ascertain an identifier of the subscriber A2 allowing RA2 to transfer to T2 the data of the stream of the electronic communication service between T1 and T2, such as requested by A1. In a preliminary step, the terminal T1 interrogates with an FQDN address of A2 a DNS server, so as to obtain a so-called “primary” identifier of A2 allowing it to identify the MSID server of the service provider of A2. An MSID server contains the primary and secondary identifiers specific to a service provider (Master to Secondary Identifier Directory).

The MSID server illustrated is specific to the service provider of A2 and ascertains the so-called “secondary” identifiers of the subscribers of this service provider. These secondary identifiers serve to identify at one and the same time a subscriber and a service used by this subscriber. The main function of an MSID server is to return a secondary identifier as a function of a primary identifier and of a given service. The list of secondary identifiers that are contained by an MSID server is updated by its manager service provider each time that a subscriber signs up to a particular service or cancels it.

The MSID server implements a device for resolving subscriber identifiers.

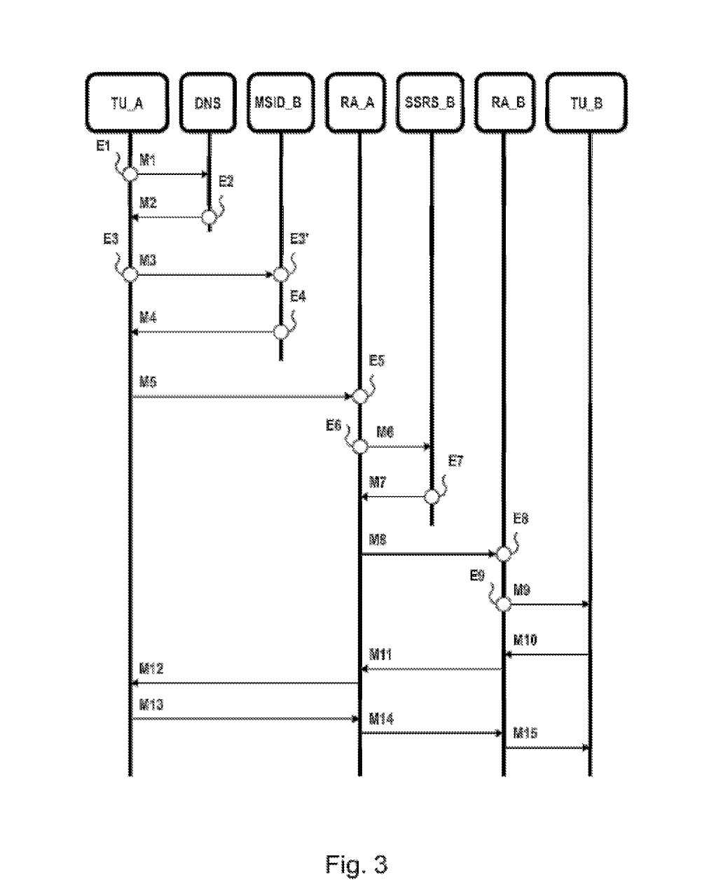

In the embodiments described, the hardware architecture of the MSID server comprises the elements that are found in a conventional computer. The MSID server comprises in particular a processor 11, a random-access memory 12 and a read-only memory 13 comprising a certain number of applications that can be executed by the processor 11 in cooperation with the random-access memory 12. The read-only memory 13 constitutes a recording medium in accordance with the invention. This recording medium comprises a computer program comprising instructions to allow the execution, by the processor 11, of the steps of the method for resolving subscriber identifiers in accordance with the invention and which will be described with reference to FIG. 3.

The SSRS server illustrated is specific to the service provider of A2 and to the type of service requested by A1. The SSRS server (for Service Specific Resolution System) contains the addresses of the access routers to which are attached the subscribers of the service provider of A2 using a service of the same type as that requested by A1. Interrogated by the router RA1, the SSRS server returns the address of the access router RA2. The list of addresses of access routers which is contained in the SSRS server is updated with the aid of information communicated by the access routers themselves.

The SSRS server implements a device for resolving access router addresses and a device for updating a table of addresses of access routers.

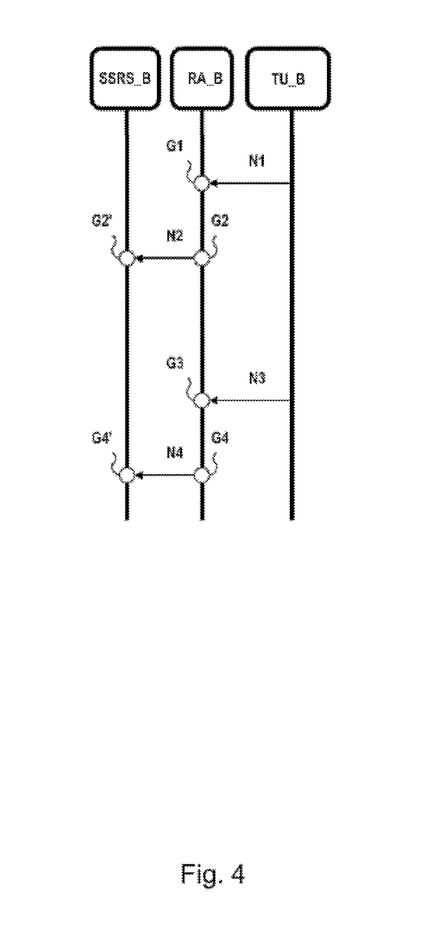

In the embodiments described, the hardware architecture of the SSRS server comprises the elements that are found in a conventional computer. The MSID server comprises in particular a processor 21, a random-access memory 22 and a read-only memory 23 comprising a certain number of applications that can be executed by the processor 21 in cooperation with the random-access memory 22. The read-only memory 23 constitutes a recording medium in accordance with the invention. This recording medium comprises a computer program comprising instructions to allow the execution, by the processor 21, of the steps of the method for resolving access router addresses in accordance with the invention and which will be described with reference to FIG. 3, and of the steps of the method for updating a table of addresses of access routers in accordance with the invention and which will be described with reference to FIG. 4.

The access router RA2 illustrated contains inter alia the attachment IP addresses of the terminals associated with the subscriber A2 which are attached thereto. The access router RA2 is not necessarily managed by the service provider of A2, nor of A1, but it communicates, when necessary, information making it possible to update the SSRS server.

The access router RA2 implements a device for updating a table for resolving attachment IP addresses.

In the embodiments described, the hardware architecture of the access router RA2 comprises the elements that are found in a conventional computer. The access router RA2 comprises in particular a processor 41, a random-access memory 42 and a read-only memory 43 comprising a certain number of applications that can be executed by the processor 41 in cooperation with the random-access memory 42. The read-only memory 43 constitutes a recording medium in accordance with the invention. This recording medium comprises a computer program comprising instructions to allow the execution, by the processor 41, of the steps of the method for updating a table of attachment IP addresses in accordance with the invention and which will be described with reference to FIG. 4. This description of the hardware architecture of the access router RA2 applies mutatis mutandis to the access router RA1.

The following figures illustrate in greater detail embodiments of the invention.

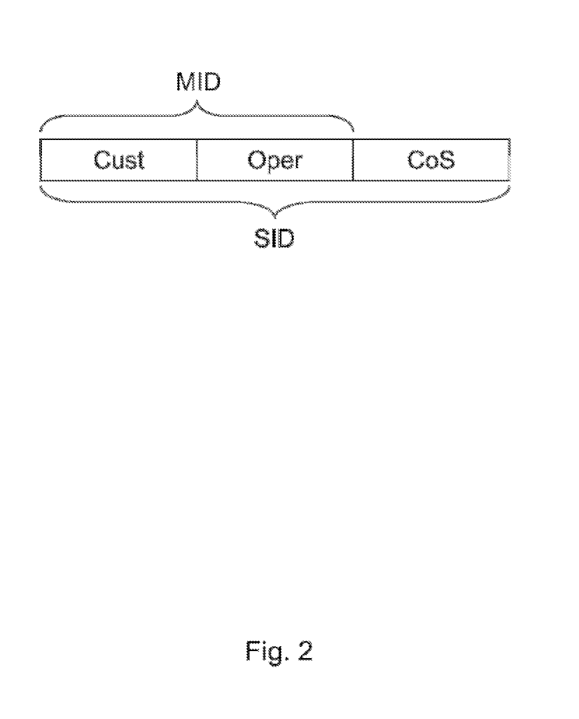

FIG. 2 represents in a schematic manner an exemplary structure of the primary and secondary subscriber identifiers according to a particular embodiment of the invention.

A primary identifier MID (Master IDentifier) comprises at least:
a field Cust, identifying a customer or user of a service provider,
a field Oper, identifying a service provider.

A secondary identifier SID (Secondary IDentifier) comprises at least:
a field Cust, identifying a customer or user of a service provider,
a field Oper, identifying a service provider,
a field CoS, identifying a service.

In this example, the subscriber secondary identifier is specific to a service and contains the primary identifier of the subscriber, the subscriber primary identifier is not specific to a service and contains the identifier of the service provider of the subscriber. Of course, other secondary and primary structures of identifiers can be envisaged.

In the invention, the subscriber primary identifiers are obtained by prior consultation of a base resolution server called “DNS”. As a function of an arbitrary identifier designating a user on a network, also called an FQDN address, the DNS returns a subscriber primary identifier nonspecific to a service, but making it possible to identify the service provider of this user.

The methods for resolving subscriber identifiers, for resolving access router addresses, and for routing the data are now presented in conjunction with FIG. 3.

FIG. 3 represents a particular example of implementation, according to a particular embodiment of the invention, of an electronic communication service between a first subscriber A to a first service provider FA and a second subscriber B to a second service provider FB, relying inter alia on the use of the method of subscribers identifier resolution.

The subscriber A has a user terminal, referenced TU_A in FIG. 3, attached to an access router, referenced RA_A, and identified by RA_A with the aid of the pair {SID_A; IP_A}, where SID_A is the secondary identifier of A and IP_A an attachment IP address used on the user terminal TU_A by the service to which A has subscribed. The user terminal TU_A can be for example a mobile telephone attached to a base station, or else a computer attached to a WiFi hotspot. Likewise, the subscriber B has a user terminal, referenced TU_B in FIG. 3, attached to an access router RA_B and identified by RA_B with the aid of the pair {SID_B; IP_B}.

The user terminal TU_A emits in the course of a step E1 a request M1 to the server referenced DNS in FIG. 3, comprising the FQDN address of the subscriber B. In the course of a step E2, the DNS server returns to the user terminal TU_A a response M2 comprising a primary identifier of the subscriber B, nonspecific to a service. This primary identifier, called MID (Master IDentifier), consists of two fields: a field containing an identifier of the subscriber nonspecific to a service, and a field containing an identifier of the service provider of the subscriber.

A primary identifier MID can be for example the customer number corresponding to a subscription to a residential Internet access, or any other number identifying at one and the same time a subscriber as party to a contract for the provision of one or more services, and the provider of said services.

Once the primary identifier MID of B has been obtained, called MID_B, the subscriber identifier resolution method according to the invention is implemented. By virtue of the field “identifier of the service provider” of MID_B, the user terminal of A, TU_A knows which MSID server to interrogate.

In the course of a step E3, the user terminal TU_A sends a request M3 to the MSID server of B, referenced MSID_B in FIG. 3, comprising the primary identifier MID_B as well as a subscriber identifier of A called SID_A (secondary identifier of the subscriber, or Secondary IDentifier) specific to the service requested by the subscriber A. A secondary identifier SID consists of two fields: a field containing the primary identifier MID, and a field containing a service identifier, called CoS (Class of Service).

An SID can be for example an identifier of a call service, video service or gaming service for example.

During a step E3′, the server MSID_B extracts from the secondary identifier SID_A the service identifier CoS_A, that is to say the service identifier requested by A. The server MSID_B consults its table for resolving subscriber identifiers consisting of a list of the secondary identifiers of all its subscribers. The server MSID_B establishes the list of the secondary identifiers whose primary identifier field is equal to MID_B and whose service identifier field is equal to CoS_A.

In an advantageous embodiment, in the case where no entry in the table is found, the server MSID_B searches among the secondary identifiers of the subscriber B for those whose service identifier field is different from CoS_A but represents a service compatible with that identified by CoS_A.

In a step E4, the server MSID_B sends to the user terminal TU_A a response message M4 containing either the information that the communication is not possible (if no entry in the table of MSID_B satisfies the request), or the secondary identifier of the subscriber B for the service requested by A, that is to say SID_B. The secondary identifier SID_B contains CoS_B in its service identifier field; CoS_B can be equal to CoS_A and represent the same service, or be different and represent a compatible service.

In a step E5, the access router of A, RA_A, receives a data message M5 intended for the subscriber B. The message M5 comprises the secondary identifier SID_A, the secondary identifier SID_B, as well as the payload data. In order to determine the routing of the payload data, the access router RA_A must ascertain the address LOC_B of the access router of B, RA_B.

In a step E6, the access router RA_A extracts the secondary identifier SID_B of the message M5 so as to determine the service provider of the subscriber B as well as the service concerned, and sends a request message M6 to a server for resolving access router addresses, which is specific to the service provider of the subscriber and specific to the service identified by the service identifier CoS_B. This server for resolving access router addresses is referenced SSRS_B in FIG. 3.

In a step E7, the server SSRS_B consults its table for resolving access router addresses specific to the service identified by CoS_B, consisting of a list of all the pairs {subscriber secondary identifier SID; access router address LOC}, containing CoS_B in the service identifier field of the SID. The server SSRS_B returns in a response message M7 the address of the access router LOC_B corresponding to the secondary identifier SID_B.

In an advantageous embodiment, the server SSRS_B returns in the message M7 all the possible responses in the case where several pairs {SID_B; LOC} exist with different values of LOC. This allows the access router RA_A to make a choice between several addresses of access routers RA_B, in case of necessity.

If no pair {SID; LOC} is suitable in the table for resolving access router addresses of the server SSRS_B, the response message M7 contains the information that the communication session cannot be established.

In an advantageous embodiment, if such is the case, the subscriber A instructs the access router RA_A to repeat step E5 using a secondary identifier SID_B with a different value CoS_B, on condition that in the course of step E4, the server MSID_B has responded with several values of SID_B.

In a step E8, the access router of B, RA_B, receives from the access router of A, RA_A, a data message M8. M8 comprises the secondary identifier SID_A, the secondary identifier SID_B, the address of the access router RA_A, the address of the access router RA_B, as well as the payload data. In order to determine the routing of the data to their final destination, the access router RA_B must ascertain the attachment IP address associated with the secondary identifier SID_B on the user terminal of B, TU_B. The access router RA_B consults its table for resolving attachment IP addresses, consisting of a list of all the pairs {secondary identifier SID; attachment IP address}, that is to say of a list of all the user terminals attached to the access router RA_B, these terminals being identified by a subscriber secondary identifier and an attachment IP address.

In an advantageous embodiment, if several attachment IP addresses in the table correspond to the secondary identifier SID_B, the access router RA_B makes a choice by using additional information, communicated beforehand by the subscriber B about his preferences relating to the service identified by CoS_B.

In a step E9, the router RA_B transmits to the user terminal TU_B the message M9 comprising the secondary identifier SID_A, the secondary identifier SID_B as well as the payload data, by using the attachment IP address selected from the table for resolving attachment IP addresses during the previous step.

For the rest of the communication session between the subscriber A and the subscriber B, payload data can be exchanged between the user terminals TU_A and TU_B via the access routers RA_A and RA_B, in the upstream direction by messages M10, M11, M12, or in the downstream direction by messages M13, M14, M15, without resorting to the resolution servers DNS, MSID_B or SSRS_B, by virtue of the information stored by the access routers RA_A and RA_B in the course of steps E5 and E8.

The methods for updating a table for resolving attachment IP addresses, and for updating an access router addresses resolution table are now presented in conjunction with FIG. 4.

FIG. 4 represents a particular example of implementation, according to a particular embodiment of the invention, of an electronic communication service between a first subscriber A to a first service provider FA and a second subscriber B to a second service provider FB, relying inter alia on the use of the method for updating a table for resolving attachment IP addresses, and on the use of the method for updating a table for resolving access router addresses.

The subscriber B desires to declare a new service to a router RA_B or remove an already existing service from RA_B. This can be for example the declaration of the possession of a call service or video service via a mobile telephone attached to a base station or else a computer attached to a WiFi hotspot.

In steps G1 to G4, the user terminal TU_B used by the subscriber B for a service identified by CoS_B is identified in a unique manner by a pair {secondary identifier SID_B, address IP_B}. Steps G1 and G2 relate to the case of an attachment, while steps G3 and G4 relate to the case of a detachment.

In a step G01, the access router RA_B receives from the user terminal TU_B a message N1 relating to the attachment of a user terminal TU_B identified by the pair {secondary identifier SID_B; address IP_B1}. The access router RA_B adds the pair {secondary identifier SID_B; address IP_B1} to its table for resolving attachment IP addresses.

In a step G2, the access router RA_B determines whether this addition must trigger an update message N2 to the server SSRS_B. If the pair {secondary identifier SID_B; address IP_B1} is not the first containing SID_B in the table for resolving attachment IP addresses, that is to say if there also exists at least one other pair {secondary identifier SID_B; address IP_B2} with address IP_B2 different from address IP_B1, no update message N2 is sent. If conversely the pair {secondary identifier SID_B; address IP_B1} is the first containing SID_B in the table for resolving attachment IP addresses, an update message N2 is sent to the server SSRS_B, comprising an add instruction and the pair {secondary identifier SID_B; access router address LOC_B}, LOC_B being the address of the access router RA_B.

In order to determine to which SSRS server to send the update message N2, the access router RA_B uses the fields of the secondary identifier SID_B making it possible to identify the service provider and the service concerned.

In a step G2′, the server SSRS_B adds the pair {secondary identifier SID_B; access router address LOC_B} to its table for resolving access router addresses.

In a step G3, the access router RA_B receives from the user terminal TU_B a message N3 relating to the detachment of a user terminal identified by the pair {secondary identifier SID_B; address IP_B3}. The access router RA_B removes the pair {secondary identifier SID_B; address IP_B3} from its table for resolving attachment IP addresses.

In a step G4, the access router RA_B determines whether this removal must trigger an update message N4 to the server SSRS_B. If the pair {secondary identifier SID_B; address IP_B3} is not the only one in the table to contain SID_B, that is to say if even after removal there exists at least one other pair {secondary identifier SID_B; address IP_B4} with address IP_B4 different from address IP_B3, no update message N2 is sent to the server SSRS_B.

If conversely the pair {secondary identifier SID_B; address IP_B3} was the only one in the table, before its removal, to contain SID_B, an update message N2 is sent to the server SSRS_B, comprising a remove instruction and the pair {secondary identifier SID_B; access router address LOC_B}, LOC_B being the address of the access router RA_B.

In a step G4′, the server SSRS_B removes the pair {secondary identifier SID_B; access router address LOC_B} from its table for resolving access router addresses.

In an advantageous embodiment, if one or more attachment IP addresses resolution table updates take place in the course of a communication session, and affect the value of LOC_B, the continuity of the session can be ensured by virtue of the message M11 referenced in FIG. 3, on condition that M11 includes LOC_B in addition to the payload data of the session. Thus, the access router RA_A is informed in real time of the changes of address of the access router RA_B.

1. A method for resolving subscriber identifiers for implementing an electronic communication service supported by an electronic communications network, between a first subscriber to a first service provider and a second subscriber to a second service provider, wherein the method comprises the following steps:
reception by a device of a subscriber identifier resolution request comprising a primary identifier of the second subscriber and at least one identifier of the service requested by the first subscriber,
obtaining by the device at least one secondary identifier of the second subscriber, corresponding to the service requested by the first subscriber, by consultation of a table for resolving subscriber identifiers, this table associating a secondary identifier of a subscriber with a pair {primary identifier of said subscriber; identifier of a service signed up to by said subscriber}, and
sending from the device a subscriber identifier resolution response comprising the secondary identifier of the second subscriber, corresponding to the service requested by the first subscriber.

2. The method for resolving subscriber identifiers as claimed in claim 1, wherein the secondary identifier of a subscriber comprises at least the following fields:
primary identifier of the subscriber,
service identifier,
and wherein the primary identifier of the subscriber comprises at least the following fields:
identifier of the subscriber,
identifier of the service provider of the subscriber).

3. The method for resolving subscriber identifiers as claimed in claim 2, wherein the subscriber identifiers resolution request comprises a secondary identifier of the first subscriber corresponding to the requested service, and wherein the method comprises a step of extracting the service identifier on the basis of the secondary identifier of the first subscriber.

4. The method for resolving subscriber identifiers as claimed in claim 1, wherein, if the table for resolving subscribers does not contain any entry corresponding to the pair {primary identifier of the second subscriber; identifier of the service requested by the first subscriber}, the subscriber identifiers resolution response comprises at least one secondary identifier of the second subscriber whose service identifier field is compatible with the service requested by the first subscriber.

5. (canceled)

6. A method for updating a table for resolving attachment IP addresses, wherein the method comprises the following steps:
reception by a device of a modification message relating to attachment of a subscriber to an electronic communications network, comprising a secondary identifier of the subscriber and an attachment IP address,
addition or removal by the device, in a table for resolving attachment IP addresses, of an entry corresponding to the pair {secondary identifier of the subscriber; attachment IP address}, and
triggering by the device of a sending of an update message in respect of a table for resolving access router addresses, as a function of a type of modification relating to the attachment, and of a state of the table for resolving attachment IP addresses.

7-16. (canceled)

17. A device for resolving subscriber identifiers for implementing an electronic communication service supported by an electronic communications network, between a first subscriber to a first service provider and a second subscriber to a second service provider, wherein the device comprises:
means for receiving a subscriber identifier resolution request comprising a primary identifier of the second subscriber and at least one identifier of the service requested by the first subscriber,
means for obtaining at least one secondary identifier of the second subscriber, corresponding to the service requested by the first subscriber, by consultation of a table for resolving subscriber identifiers, this table associating a secondary identifier of a subscriber with a pair, which includes: a primary identifier of said subscriber; and an identifier of a service signed up to by said subscriber, and
means for sending a subscriber identifier resolution response comprising the secondary identifier of the second subscriber, corresponding to the service requested by the first subscriber.

18. A device for updating a table for resolving attachment IP addresses, wherein the device comprises:
means for receiving a modification message relating to an attachment of a subscriber to an electronic communications network, comprising a secondary identifier of the subscriber and an attachment IP address,
means for addition or removing, in a table for resolving attachment IP addresses, an entry corresponding to a pair, which includes: the secondary identifier of the subscriber; and the attachment IP address, and
means for triggering a sending of an update message in respect of a table for resolving access router addresses, as a function of the type of modification relating to the attachment, and of a state of the table for resolving attachment IP addresses.
